(19) United States
(12) Patent Application Publication
(10) Pub. No.: US 2009/0055628 A1
(43) Pub. Date: Feb. 26, 2009

(54) METHODS AND COMPUTER PROGRAM PRODUCTS FOR REDUCING LOAD-HIT-STORE DELAYS BY ASSIGNING MEMORY FETCH UNITS TO CANDIDATE VARIABLES

(75) Inventors: Marcel Mitran, Markham (CA); Joran S.C. Siu, Thornhill (CA); Alexander Vasilevskiy, Brampton (CA)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINE CORPORATION, Armonk, NY (US)

(21) Appl. No.: 11/842,289

(22) Filed: Aug. 21, 2007

(51) Int. Cl. G06F 9/312

(52) U.S. Cl. 712/207; 712/E09.033

(57) ABSTRACT

Assigning each of a plurality of memory fetch units to any of a plurality of candidate variables to reduce load-hit-store delays, wherein a total number of required memory fetch units is minimized. A plurality of store/load pairs are identified. A dependency graph is generated by creating a node Nx for each store to variable X and a node Ny for each load of variable Y and, unless X=Y, for each store/load pair, creating an edge between a respective node Nx and a corresponding node Ny; for each created edge, labeling the edge with a heuristic weight; labeling each node Nx with a node weight Wx that combines a plurality of respective edge weights of a plurality of corresponding nodes Nx such that Wx=Σωₓⱼ; and determining a color for each of the graph nodes using k distinct colors wherein k is minimized such that no adjacent nodes joined by an edge between a respective node Nx and a corresponding node Ny have an identical color; and assigning a memory fetch unit to each of the k distinct colors.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to computer architecture and, more particularly, to methods and computer program products for reducing or eliminating “load-hit-store” delays.

2. Description of Background

Some computer architectures, including System-p and System-z, have performance bottlenecks known as “load-hit-store” delays. Such bottlenecks occur in situations where a store is closely followed by a fetch from a common memory fetch unit. A memory fetch unit is an association of memory locations that share a temporal dependency. This association, specific to the timing of the architectural characteristics under observation, is typically a byte, word, double-word, or page-aligned information. For a “load-hit-store”, a fetch request typically needs to wait K extras cycles for the store to the memory fetch unit to complete. In practice, K varies from five to several hundreds of cycles depending on the architecture.

One existing approach for mitigating the problem of “load-hit-store” delays is a technique called instruction scheduling. Instruction scheduling attempts to fill in a slot of K cycles between the store and the fetch with instructions that are independent of the store and fetch operations. Instruction scheduling, however, will not be effective unless enough independent instructions are available to hide the “load-hit-store” delay, or unless the store and fetch are in different scheduling blocks. Accordingly, what is needed is an improved technique for reducing or eliminating “load-hit-store” delays.

### SUMMARY OF THE INVENTION

The shortcomings of the prior art are overcome and additional advantages are provided by assigning each of a plurality of memory fetch units to any of a plurality of candidate variables to reduce or eliminate load-hit-store delays, wherein a total number of required memory fetch units is minimized. The plurality of memory fetch units are assigned to any of the plurality of candidate variables by identifying a plurality of store/load pairs wherein a store to variable X of the candidate variables is within M instruction cycles of a load of variable Y of the candidate variables, M being a positive integer greater than one; generating a dependency graph by creating a node Nx for each store to variable X and a node Ny for each load of variable Y and, unless X=Y, for each store/load pair of the plurality of store/load pairs, creating an edge between a respective node Nx and a corresponding node Ny; for each created edge, labeling the edge with a heuristic weight ω_{xy}, wherein ω_{xy} is determined by at least one of: (a) a probability that a load of variable Y is executed given that a store of variable X is executed, or (b) a cost of the load-hit-store for variables X and Y; labeling each node Nx with a node weight Wx that combines a plurality of respective edge weights of a plurality of corresponding nodes Nx such that Wx=Σωₓⱼ; and determining a color for each of the graph nodes using k distinct colors wherein k is minimized such that no adjacent nodes joined by an edge between a respective node Nx and a corresponding node Ny have an identical color; and assigning a memory fetch unit to each of the k distinct colors.

Computer program products corresponding to the above-summarized methods are also described and claimed herein. Other methods and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### TECHNICAL EFFECTS

Assigning each of a plurality of memory fetch units to any of a plurality of candidate variables serves to reduce or eliminate load-hit-store delays. This assignment is performed in a manner such that the total number of required memory fetch units is minimized. Illustratively, reducing or eliminating load-hit-store delays is useful in the context of stack-based languages wherein a compiler assigns a plurality of stack-frame slots to hold temporary expressions. Alternatively or additionally, any garbage collected language may utilize the assignment techniques disclosed herein for re-factoring heaps to thereby mitigate load-hit-store delays in the context of any of a variety of software applications.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flowchart illustrating an exemplary method for assigning each of a plurality of memory fetch units to any of a plurality of candidate variables subject to load-hit-store delays.

FIGS. 2-6 depict generation of a first illustrative dependency graph using the method of FIG. 1.

FIGS. 7-11 depict generation of a second illustrative dependency graph using the method of FIG. 1.

### DETAILED DESCRIPTION OF THE INVENTION

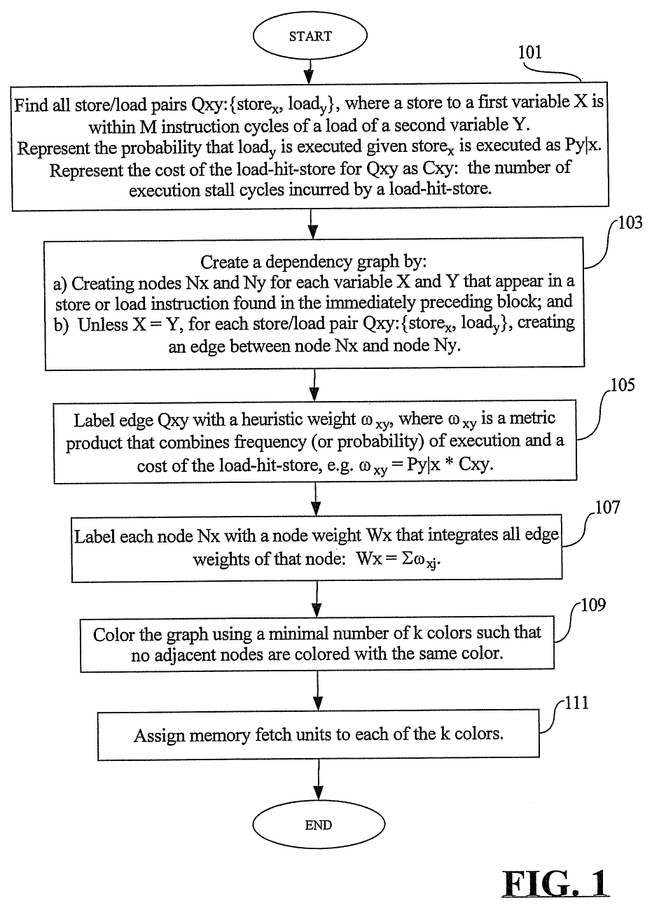

FIG. 1 is a flowchart illustrating an exemplary method for assigning each of a plurality of memory fetch units to any of a plurality of candidate variables subject to load-hit-store delays. The procedure commences at block 101 where, given a load-hit-store delay of N cycles, a plurality of store/load pairs Qxy: {storeₓ, load_{y}} are located, such that a store to variable X is within M instruction cycles of a load of variable Y. M is a positive integer greater than one. Represent the probability that load_{y} is executed given stores is executed as Py|x. Represent a cost of the load-hit-store for Qxy as Cxy, which typically would be the number of execution stall cycles incurred by the load-hit-store.

Next, at block 103, a dependency graph is created by: a) creating a node Nx for each store to variable X and creating a node Ny for each load of variable Y; and b) unless X=Y, for each store/load pair of the plurality of store/load pairs Qxy: {storeₓ, load_{y}}, creating an edge between a respective node Nx and a corresponding node Ny. At block 105, for each edge created in the immediately preceding block, the edge is labeled with a heuristic weight ω_{xy}, where ω_{xy} is a metric product that combines frequency (or probability) of execution and the cost of the load-hit-store, e.g. ω_{xy}=Py|x*Cxy.

At block 107, each node Nx is labeled with a node weight Wx that integrates all edge weights of that node such that Wx=Σωₓⱼ. Next, at block 109, a coloring for each of the graph nodes is determined using a minimal number of k distinct colors such that no adjacent nodes joined by an edge between a respective node Nx and a corresponding node Ny have an identical color. At block 111, a respective memory fetch unit is assigned to each of a plurality of corresponding k distinct colors.

In performing block 109, many different heuristics for approximating optimal graph coloring exist. For the sake of completeness and without loss of generality, one example of a graph coloring algorithm is presented herein that may be near-optimal in most load-hit-store situations: Color the nodes in decreasing order of weight Wi. When determining a color for a node, first identify any colors already used in the graph which are not used to color an adjacent node (i.e., a node's neighbors). Out of these identified colors, pick the color with most space available, where space is defined as follows: Space(color i)=Size of memory fetch unit−Σ(node of color i*node size), where “node size” is the size of the variable occupying a node, for example 4 bytes for an integer variable. Make sure the determined color has enough corresponding memory space to hold the variable corresponding to the node to be colored. If no such color is available from the set of colors already in the graph, a new color must be selected.

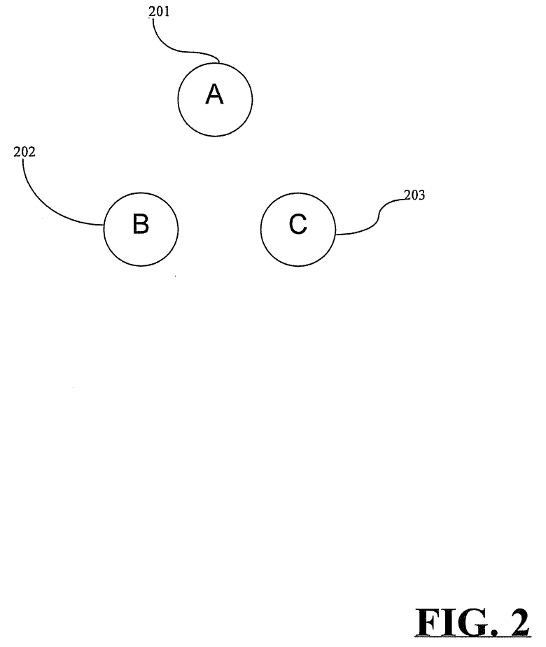

FIGS. 2-6 depict generation of a first illustrative dependency graph using the method of FIG. 1 wherein the dependency graph represents an instruction sequence. The instruction sequence, provided below, involves three variables: A, B and C. A heuristic weight between any store-load pair is defined as a fixed value of two. Frequency information is not available. Each memory fetch unit can fit up to two variables.

### Instruction Sequence:

Store A
Load B
Store C
Load A
Store B
Load A

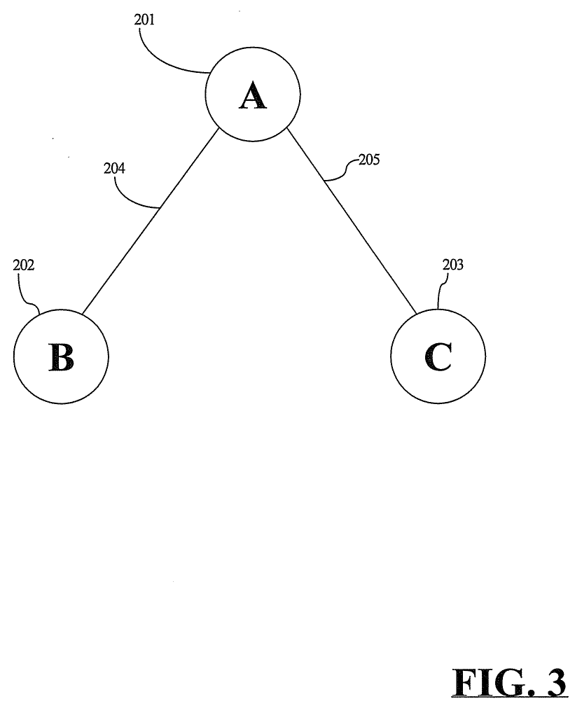

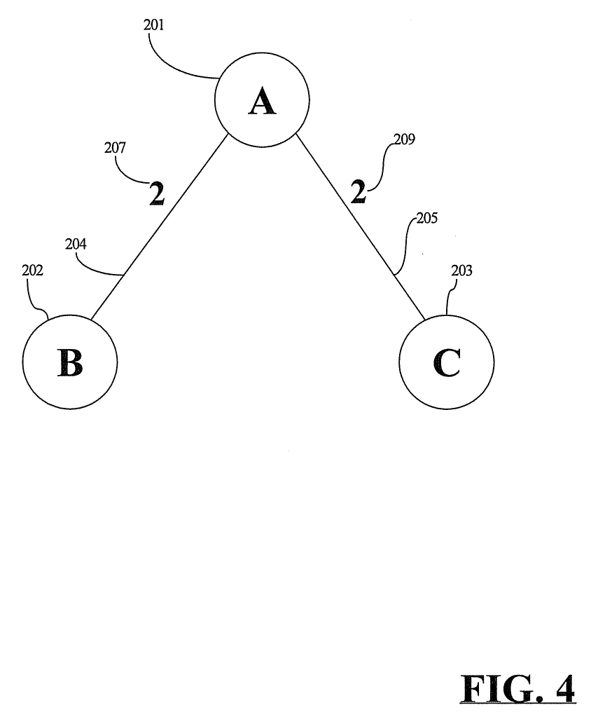

Accordingly, node pairs are identified as {Store A, Load B}, {Store C, Load A}, and {Store B, Load A}. With reference to FIG. 2, a dependency graph is created by creating nodes for each variable. A first node, denoted as node A 201, represents variable A. Similarly, a second node, denoted as node B 202, represents variable B, and a third node, denoted as node C 203, represents variable C. At FIG. 3, edges are created for each store/load pair shown in FIG. 2. A first edge 204 (FIG. 3) joins node A 201 and node B 202. A second edge 205 joins node A 201 and node C 203. FIG. 4 depicts labelling each of the edges of FIG. 3 with heuristics. First edge 204 (FIG. 4) is labelled with a first heuristic 207 in the form of a number 2. Similarly, second edge 205 is labelled with a second heuristic 209 in the form of a number 2.

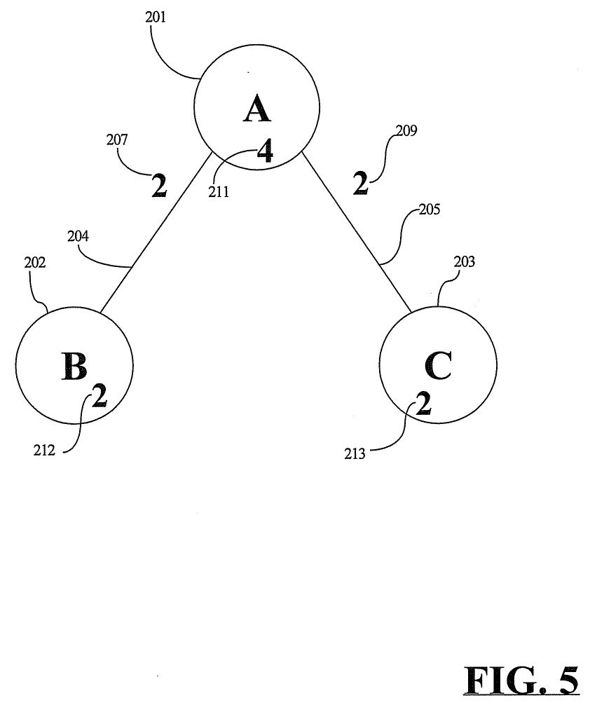

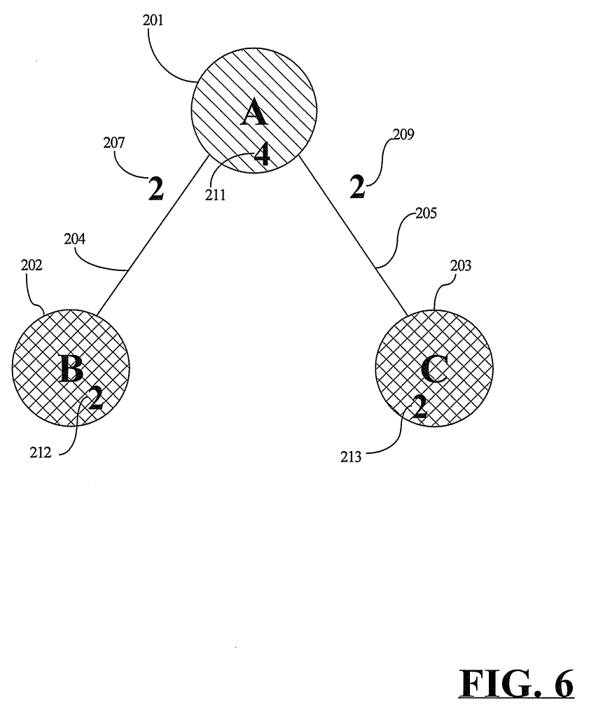

At FIG. 5, each node in FIG. 4 is labelled with a node weight. Node A 201 (FIG. 5) is labelled with a first weight 211 in the form of a number 4. Likewise, node B 202 is labelled with a second weight 212 in the form of a number 2, and node C 203 is labelled with a third weight 213 in the form of a number 2. With reference to FIG. 6, the dependency graph of FIG. 5 is colored using a first color for node A 201 (FIG. 6). A second color is used for node B 202 as well as node C 203. Note that no two adjacent (neighboring) nodes are colored with the same color. Variables are now assigned to fetch units based upon color. Variables B and C will be placed into a first memory fetch unit, whereas variable A will be placed into a second memory fetch unit. Thus the total number of required memory fetch units is two.

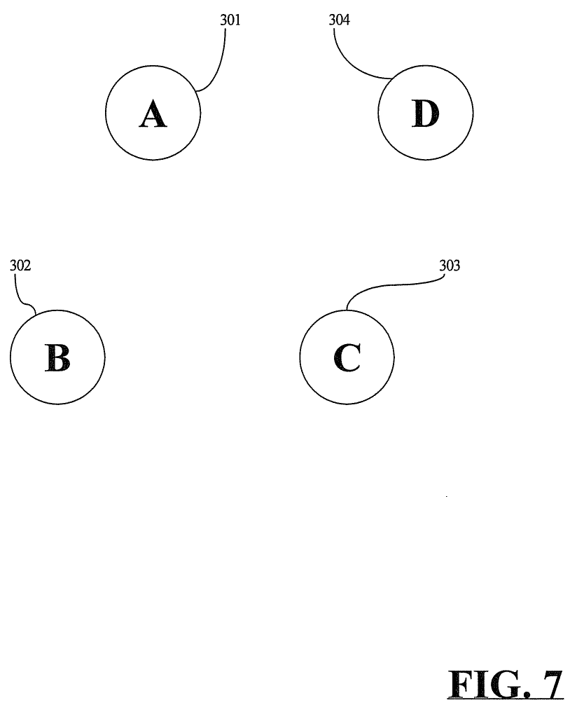

FIGS. 7-11 depict generation of a second illustrative dependency graph using the method of FIG. 1 wherein the dependency graph represents a control flow sequence. The control flow sequence, provided below, involves four variables: A, B, C, and D. A cost between any store-load pair is defined as a fixed value of ten. A true-path for the if-statement has frequency of 90%, while a false-path has frequency of 10%. Each memory fetch unit can fit up to two variables:

```
if (condition) {
    // 90% path frequency
    Store A
    Load D
} else {
    // 10% path frequency
    Store B
}
Load C
```

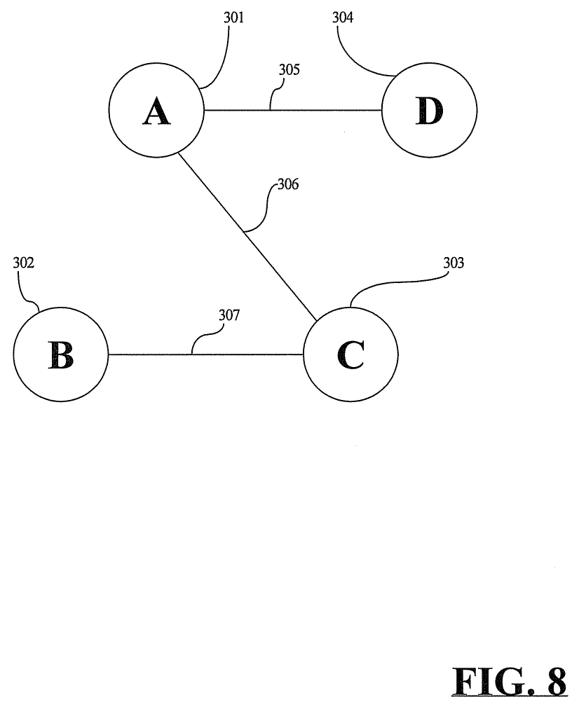

Accordingly, node pairs are identified as {Store A, Load D}-90%, {Store A, Load C}-90%, {Store B, Load C}-10%. With reference to FIG. 7, a dependency graph is created by creating nodes for each variable. A first node, denoted as node A 301, represents variable A. Similarly, a second node, denoted as node B 302, represents variable B, a third node, denoted as node C 303, represents variable C, and a fourth node, denoted as node D 304, represents variable D. At FIG. 8, edges are created for each store/load pair shown in FIG. 7. A first edge 305 (FIG. 8) joins node A 301 and node D 304. A second edge 306 joins node A 301 and node C 303. A third edge 307 joins node C 303 and node B 302.

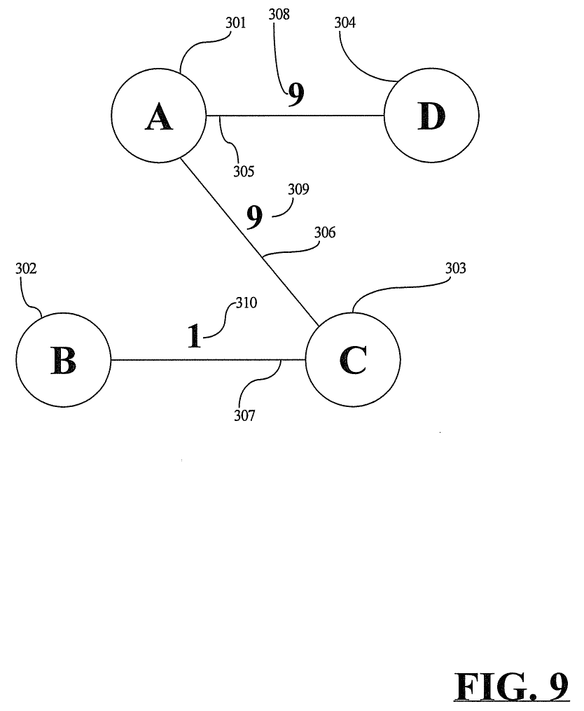

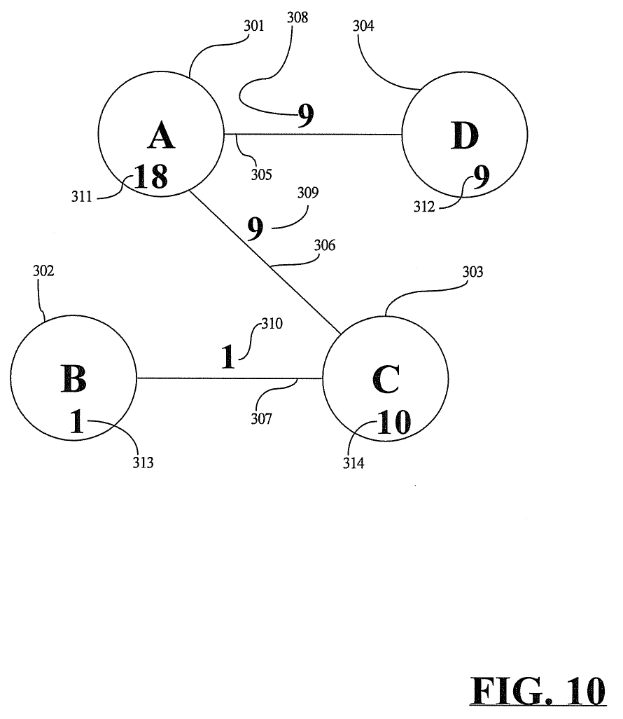

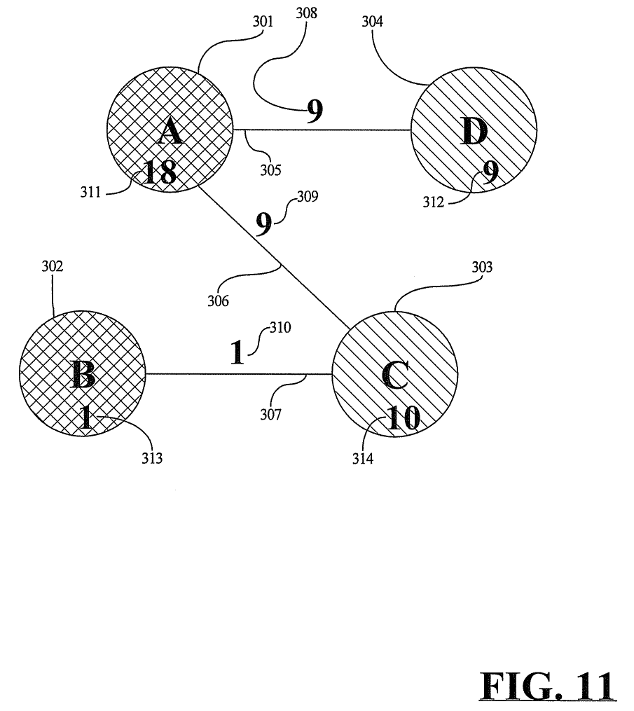

FIG. 9 depicts labelling each of the edges of FIG. 8 with heuristics. First edge 305 (FIG. 9) is labelled with a first heuristic 308 in the form of a number 9. Similarly, second edge 306 is labelled with a second heuristic 309 in the form of a number 9. Likewise, third edge 307 is labelled with a third heuristic 310 in the form of a number 1. At FIG. 10, each node of FIG. 9 is labelled with a node weight. Node A 301 (FIG. 10) is labelled with a first weight 311 in the form of a number 18. Likewise, node B 302 is labelled with a second weight 313 in the form of a number 1, node C 303 is labelled with a third weight 314 in the form of a number 10, and node D 304 is labelled with a fourth weight 312 in the form of a number 9. With reference to FIG. 11, the dependency graph of FIG. 10 is colored using a first color for nodes A 301 and B 302 (FIG. 11). A second color is used for nodes C 303 and D 304. Note that no two adjacent (neighboring) nodes are colored with the same color. Variables are now assigned to fetch units based upon color. Variables A and B will be placed into a first memory fetch unit, whereas variables C and D will be placed into a second memory fetch unit. Thus, a total of two memory fetch units are used.

The capabilities of the present invention can be implemented in software, firmware, hardware or some combination thereof. As an example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method of assigning each of a plurality of memory fetch units to any of a plurality of candidate variables to reduce or eliminate load-hit-store delays, wherein a total number of required memory fetch units is minimized, the method comprising:
identifying a plurality of store/load pairs wherein a store to variable X is within M instruction cycles of a load of variable Y, M being a positive integer greater than one;
generating a dependency graph by creating a node Nx for each store to variable X and a node Ny for each load of variable Y and, unless X=Y, for each store/load pair of the plurality of store/load pairs, creating an edge between a respective node Nx and a corresponding node Ny;
for each created edge, labeling the edge with a heuristic weight ω_{xy} determined by at least one of: (a) a probability that a load of variable Y is executed given that a store of variable X is executed, or (b) a cost of the load-hit-store for variables X and Y;
labeling each node Nx with a node weight Wx that combines a plurality of respective edge weights of a plurality of corresponding nodes Nx such that Wx=Σωₓⱼ; and
determining a color for each of the graph nodes using k distinct colors wherein k is minimized such that no adjacent nodes joined by an edge between a respective node Nx and a corresponding node Ny have an identical color; and assigning a memory fetch unit to each of the k distinct colors.

2. The method of claim 1 wherein each of the plurality of store/load pairs is denoted as Qxy: {storeₓ, load_{y}}, such that a probability that load_{y} is executed given storeₓ is executed is represented as Py|x, and such that a cost of the load-hit-store for Qxy is represented as Cxy; and wherein the heuristic weight ω_{xy}, is a metric product that combines a frequency or probability of execution and the cost of the load-hit-store as ω_{xy}=Py|x*Cxy.

3. The method of claim 1 wherein determining a color for each of the graph nodes is performed by coloring each of the graph nodes in decreasing order of weight Wx.

4. The method of claim 3 further comprising determining a second color for a second node of the graph nodes subsequent to determining a first color for a first graph node of the graph nodes, wherein the second color is selected from the k distinct colors by selecting a group of identified colors that is not used to color any node adjacent to the second node and, from the group of identified colors, selecting a color having a greatest amount of available space.

5. The method of claim 4 wherein each of the plurality of memory fetch units is defined by a corresponding unit size and assigned to a corresponding color, and the color having the greatest amount of available space is determined for a color i of the group of identified colors by the equation: (Available space for the color i)=(unit size of memory fetch unit assigned to color i)−Σ(node of color i*node size), wherein node size is defined as a size of a variable occupying a node.

6. A computer program product for assigning each of a plurality of memory fetch units to any of a plurality of candidate variables to reduce or eliminate load-hit-store delays, wherein a total number of required memory fetch units is minimized, the computer program product comprising a storage medium readable by a processing circuit and storing instructions for execution by the processing circuit for facilitating a method comprising:
identifying a plurality of store/load pairs wherein a store to variable X is within M instruction cycles of a load of variable Y, M being a positive integer greater than one;
generating a dependency graph by creating a node Nx for each store to variable X and a node Ny for each load of variable Y and, unless X=Y, for each store/load pair of the plurality of store/load pairs, creating an edge between a respective node Nx and a corresponding node Ny;
for each created edge, labeling the edge with a heuristic weight ω_{xy} determined by at least one of: (a) a probability that a load of variable Y is executed given that a store of variable X is executed, or (b) a cost of the load-hit-store for variables X and Y;
labeling each node Nx with a node weight Wx that combines a plurality of respective edge weights of a plurality of corresponding nodes Nx such that Wx=Σωₓⱼ; and
determining a color for each of the graph nodes using k distinct colors wherein k is minimized such that no adjacent nodes joined by an edge between a respective node Nx and a corresponding node Ny have an identical color; and assigning a memory fetch unit to each of the k distinct colors.

7. The computer program product of claim 6 wherein each of the plurality of store/load pairs is denoted as Qxy: {storeₓ, load_{y}}, such that a probability that load_{y} is executed given stores is executed is represented as Py|x, and such that a cost of the load-hit-store for Qxy is represented as Cxy; and wherein the heuristic weight ω_{xy}, is a metric product that combines a frequency or probability of execution and the cost of the load-hit-store as ω_{xy}=Py|x*Cxy.

8. The computer program product of claim 6 wherein determining a coloring of each of the graph nodes is performed by coloring each of the graph nodes in decreasing order of weight Wx.

9. The computer program product of claim 8 further comprising instructions for determining a second color for a second node of the graph nodes subsequent to determining a first color for a first graph node of the graph nodes, wherein the second color is selected from the k distinct colors by selecting a group of identified colors that is not used to color any node adjacent to the second node and, from the group of identified colors, selecting a color having a greatest amount of available space.

10. The computer program product of claim 9 wherein each of the plurality of memory fetch units is defined by a corresponding unit size and assigned to a corresponding color, and the color having the greatest amount of available space is determined for a color i of the group of identified colors by the equation: (Available space for the color i)=(unit size of memory fetch unit assigned to color i)−Σ(node of color i*node size), wherein node size is defined as a size of a variable occupying a node.
